(19) United States
(12) Patent Application Publication
(10) Pub. No.: US 2024/0099487 A1
(43) Pub. Date: Mar. 28, 2024

(54) SERVING AID FOR TABLEWARE

(71) Applicant: Friederike Constanze Schnitger, Bremen (DE)

(72) Inventor: Friederike Constanze Schnitger, Bremen (DE)

(21) Appl. No.: 18/275,202

(22) PCT Filed: Feb. 1, 2022
(86) PCT No.: PCT/EP2022/052287

§ 371 Date: Jul. 31, 2023

(30) Foreign Application Priority Data
Feb. 1, 2021 (DE) 10 2021 102 276.2

(51) Int. Cl. A47G 23/06

(52) U.S. Cl. CPC A47G 23/0625

(57) ABSTRACT

A serving aid comprising a first hand-support-surface configured to support the serving aid on a portion of a person's hand; a first tableware-support-portion having a first bearing-portion and a second bearing-portion for supporting a first tableware-item, the first and second bearing-portions of the first tableware-support-portion being stationary with respect to each other and oriented differently, wherein there is a force-fit operative connection between the first tableware-item, when positioned to contact the first bearing-portion and the second bearing-portion, and the serving aid.

### FIELD OF THE INVENTION

The invention relates to serving aids which assist in the handling of tableware during serving and clearing.

### BACKGROUND

In the gastronomy, but also at home, it is often desired to transport several tableware-items at the same time, for example when serving a course, when several persons want to start eating at the same time. For example, several plates can be transported at the same time with one hand/arm, for example using the so-called 2- or 3-plate technique. This requires practice and training. Furthermore, it must be considered that tableware-items to be transported may have a temperature that precludes their handling by bare hand, or at any rate may make it painful.

Therefore, serving aids are used to assist in the transport of tableware-items and avoid direct contact with them.

Serving aids to support the handling of tableware are basically known. These include, for example, trays on which several tableware-items can be transported at the same time. A tray can be used to transport many tableware-items (e.g., plates) at the same time, even of high weight, but this requires practice, strength and, because of the tray dimensions, space. For the latter reason, trays cannot be used, or can only be used with difficulty, e.g. in tightly seated rooms and/or rooms with a high number of people. Furthermore, trays may be ruled out due to the inelegant transport associated with them, e.g. in upscale gastronomy.

Furthermore, there are serving aids that allow the transport of a single tableware-item without direct contact of the transporting person (e.g. waiter, cook) with the tableware-item. Examples of this can be found, for example, in DE 27 29 289 A1 and in US 2213/0277375 A1, which disclose tableware-item handles that comprise, on the one hand, a handle for holding by a user and, on the other hand, a form-fitting and/or force-fitting mechanism for engaging a tableware-item to be transported. Such serving aids are unsuitable when it comes to transporting several pieces of tableware at the same time.

In particular, gastronomy often requires untrained or inexperienced personnel to handle a plurality of tableware-items simultaneously. In addition, such personnel often lack the proverbial housewife's hands that are used to heat, which makes handling warm or hot tableware-items at least more difficult.

The present invention is to provide solutions which enable even untrained and/or inexperienced persons to safely transport several tableware-items at the same time, advantageously also when warm or hot tableware-items are involved.

### BRIEF DESCRIPTION OF THE INVENTION

As a solution, the present invention provides articles according to the independent claims; variations thereof are defined in dependent claims.

More particularly, the present invention provides a serving aid comprising.
a. a first hand-support-surface configured to support the serving aid on a portion of a person's hand;
b. a first tableware-support-portion having a first bearing-portion and a second bearing-portion for supporting a first tableware-item, wherein
c. the first and second bearing-portions of the first tableware-support-portion being
   i. are stationary with respect to each other,
   ii. are oriented differently, wherein
d. there is a force-fit operative connection between the first tableware-item, when positioned to contact the first bearing-portion and the second bearing-portion, and the serving aid.

The first bearing-portion and the second bearing-portion of the first tableware-support-portion may be variably positionable relative to each other.

The second bearing-portion may comprise a first bearing surface and/or a second bearing surface.

The first bearing surface and the second bearing surface of the second bearing-portion may be separate surfaces from each other.

The first tableware-support-portion may comprise a first third bearing-portion, wherein the second bearing-portion of the first tableware-support-portion and the third bearing-portion of the first tableware-support-portion may be oriented substantially opposite to each other.

The first bearing-portion of the first tableware-support-portion and the third bearing-portion of the first tableware-support-portion may define a groove-like structure.

The third support portion may comprise a first bearing surface.

The first bearing surface of the third bearing-portion may oppose the first bearing surface of the second bearing-portion.

The third bearing-portion may comprise a second bearing surface.

The second support surface of the third bearing-portion may extend a plane that is tilted relative to a plane in which the first support surface of the third bearing-portion extends.

The first bearing-portion of the first tableware-support-portion may comprise a textured portion.

The textured portion of the first bearing-portion of the first tableware-support-portion may comprise a recess configured to form-fittingly receive a portion of the first tableware-item.

The serving aid may further comprise a second tableware-support-portion having a first bearing-portion for supporting a second tableware-item.

The first bearing-portion of the second tableware-support-portion and the second bearing-portion of the first tableware-support-portion may be stationary relative to each other and/or oriented substantially the same.

The second tableware-support-portion may comprise a second bearing-portion for supporting the second tableware-item.

The first bearing-portion and the second bearing-portion of the second tableware-support-portion may be stationary relative to each other and/or oriented differently.

The first bearing-portion and the second bearing-portion of the second tableware-support-portion may define a groove.

The groove may be variably adjustable.

The serving aid may comprise a third tableware-support-portion having a first bearing-portion for supporting a third tableware-item.

The first bearing-portion of the third tableware-support-portion may define a tableware-support-portion for supporting a bottom side of the third tableware-item.

The third tableware-support-portion may comprise a second bearing-portion for supporting the third tableware-item.

The first bearing-portion and the second bearing-portion of the third tableware-support-portion may be stationary with respect to each other and/or oriented the same.

At least one of the bearing-portions may comprise at least partially resilient and/or non-slip material.

Further, the present invention provides a computer software product that includes executable software code stored on a computer-readable medium that, when executed by a computer device, performs the following steps:
a. Producing a first hand-support-surface configured to support the serving aid on a portion of a person's hand;
b. Producing a first tableware-support-portion having a first bearing-portion and a second bearing-portion for supporting a first tableware-item, wherein
c. the first and second bearing-portions of the first tableware-support-portion
   i. are stationary with respect to each other,
   ii. are oriented differently such that
d. there is a force-fit operative connection between the first tableware-item, when positioned to contact the first bearing-portion and the second bearing-portion, and the serving aid.

Further, the executable software code may be adapted such that when executed by a computing device, steps are performed to produce a serving aid in any of the variations disclosed herein.

The executable software code may be adapted to control a 3D printer.

### BRIEF DESCRIPTION OF THE DRAWINGS

In the following description of the invention and of variants and preferred embodiments thereof, reference is made to the accompanying drawings, which show:

FIGS. 1a-1b are schematic representations of a variant serving aid.

FIGS. 2a-2e are schematic representations of a serving aid as defined in FIG. 1 when used for a tableware-item.

FIGS. 3a-3e are schematic representations of a serving aid as defined in FIG. 1 when used for two tableware-items.

FIGS. 4a-4c are schematic representations of a serving aid in the sense of FIG. 1 when used for three tableware-items.

FIGS. 5a-5d are schematic representations of a further variant of a serving aid.

Reference signs are not repeated in all drawings. In principle, however, a reference sign indicated in one drawing also applies to all other drawings, even if it is not indicated there.

### DETAILED DESCRIPTION

In the following, reference is made to tableware-items having a plate shape for the sake of illustration. However, this is not a limitation to such tableware-items. Rather, the term tableware-item is intended to designate any type of tableware which is intended, for example, for solid and/or liquid food and is suitable for cooperating with a serving aid in such a way that handling of the tableware-item is possible.

Tableware-items are suitable for this purpose, for example, which have a portion that is comparable to a border or flag of a plate. Such portions are also found, for example, in gravy boats with a plate-like base attached thereto. Furthermore, tableware-items may be suitable which comprise a bottom side of a substantially flat portion which can be supported by at least one of the bearing-portions of a serving aid described in more detail below.

Handling particularly refers to the transport of tableware pieces, such as occurs during serving/clearing.

The variants shown in the drawings are designed for right-handed people who, when handling tableware-items, hold a serving aid with their left hand and want to arrange or remove tableware-items there with their right hand, for example in order to position them on a table during serving.

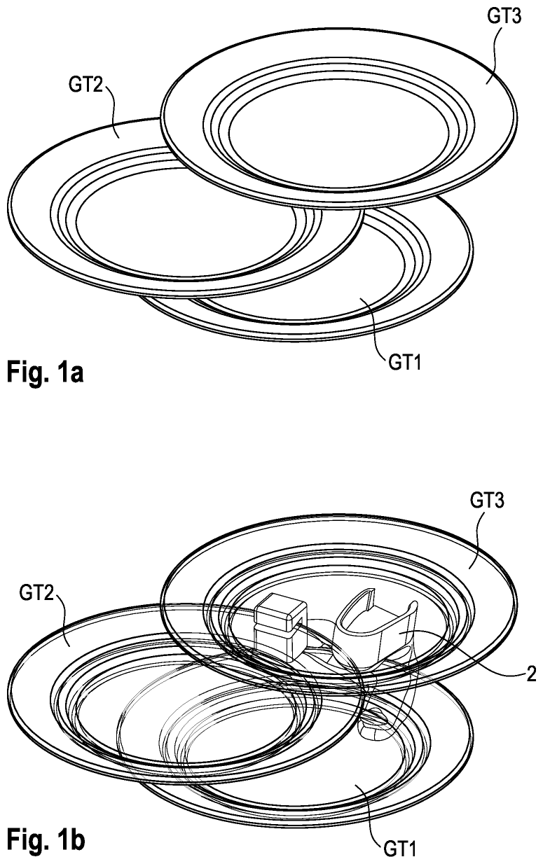

FIG. 1 shows a variant of a serving aid 2 that can be used to handle up to three tableware-items. FIG. 1a is a top view of an arrangement of 3 tableware-items GT1, GT2 and GT3 held by means of a serving aid, which is shown in FIG. 1b behind the tableware-items GT1, GT2 and GT3 shown transparently there.

As explained in more detail below, the serving aid 2 comprises different portions in each of which a tableware-item can be arranged. Such a portion is also referred to as a tableware-support-portion. Referring to FIG. 1, there are 3 tableware-support-portions, namely a first tableware-support-portion for holding a first tableware-item GT1, a second tableware-support-portion for holding a second tableware-item GT 2, and a third tableware-support-portion for holding a third tableware-item GT3,

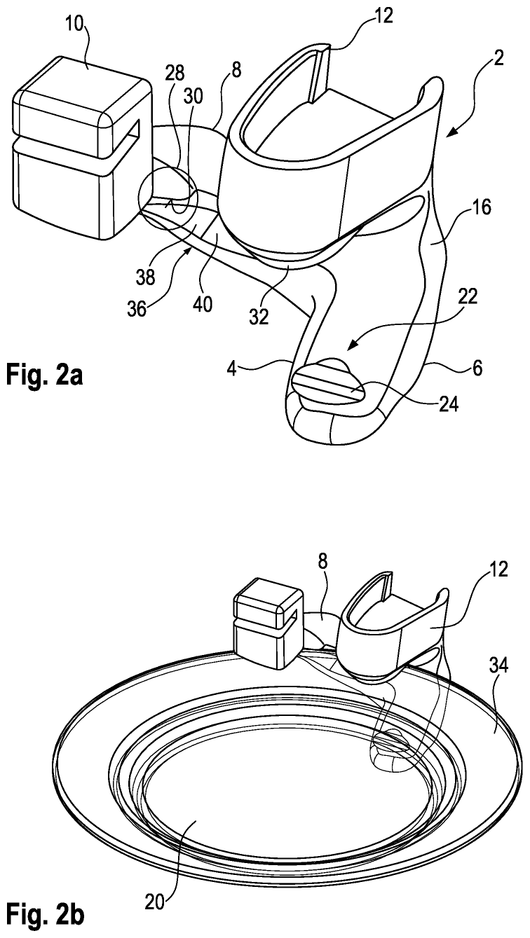

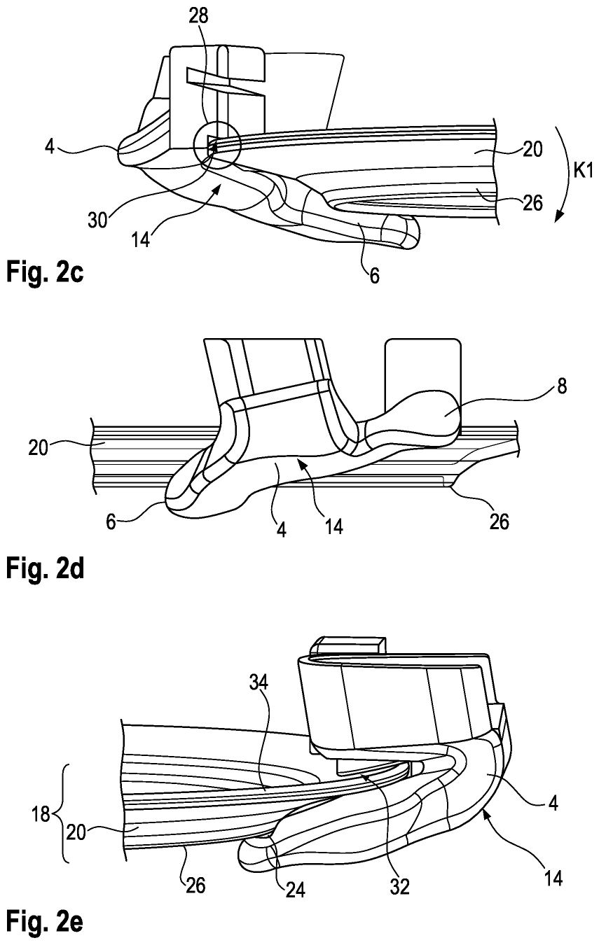

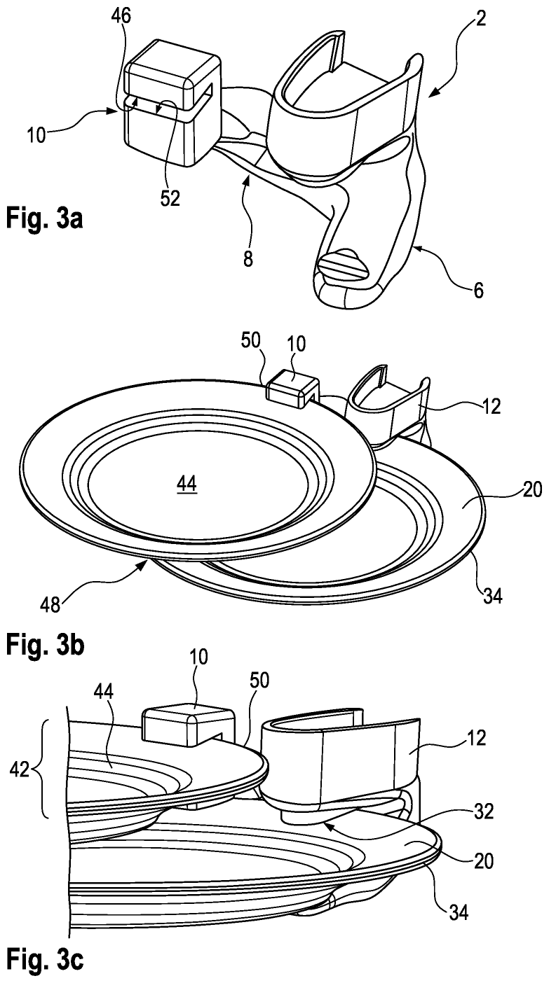

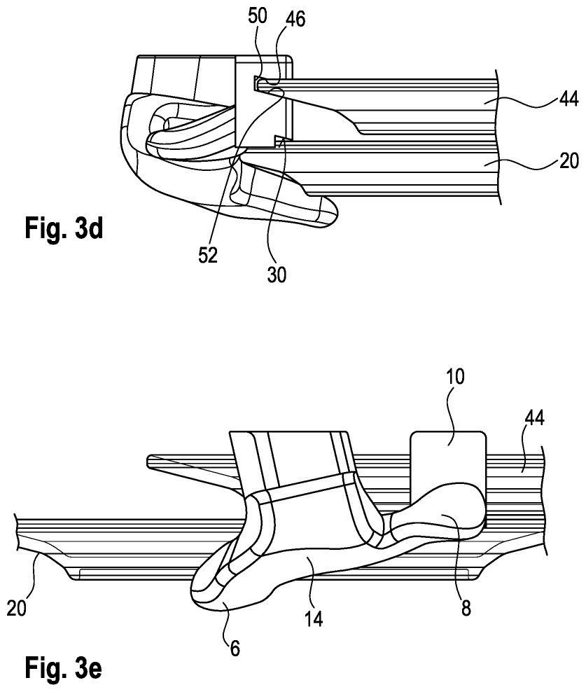

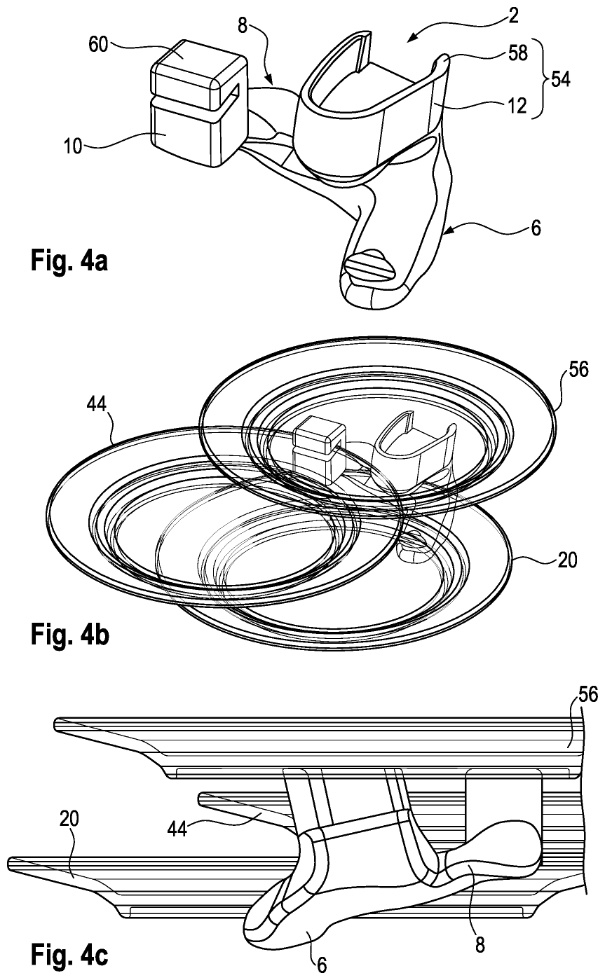

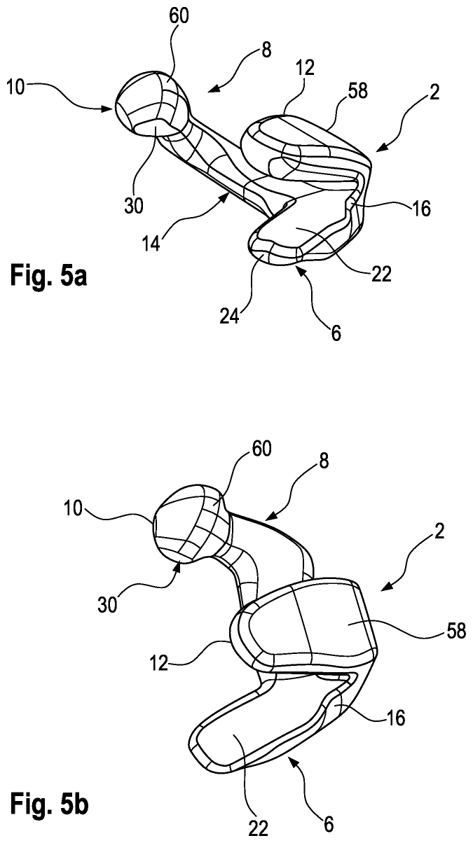

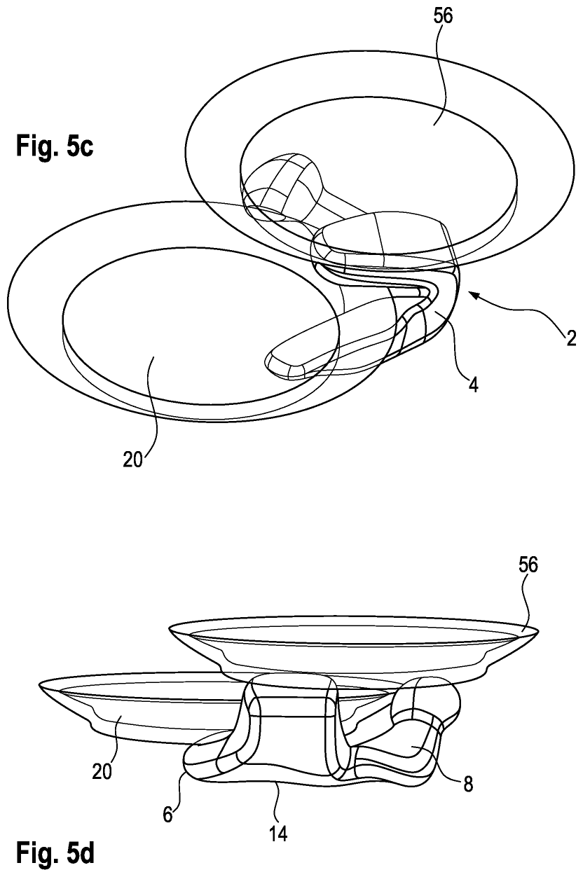

FIGS. 2, 3 and 4 show schematic representations of a serving aid 2 as defined in FIG. 1 when used for one tableware-item (FIG. 2), two tableware-items (FIG. 3) and three tableware-items (FIG. 4). FIG. 5 shows schematic illustrations of a further variant of a serving aid.

The serving aid 2 comprises a base body 4, which comprises a first finger-like structure 6 and a second finger-like structure 8. At a free end of the finger-like structure 8, a first support structure 10 extends upwardly away as shown. Furthermore, there is a second support structure 12 which also extends upwardly away as shown, for example from the center of the base body 4.

On its lower side, as shown, the base body 4 is at least partially configured to provide a hand-support-surface 14.

The hand-support-surface 14 serves to support the serving aid 2 on the palm of a user's hand. In use, this may be particularly so that the bottom side of the finger-like structure 6 rests on the user's index finger and/or middle finger and/or the bottom side of the finger-like structure 8 rests on the user's little finger and/or ring finger. The portion of the hand resting surface 14 in the center of the base body 4 would thereby support on the ball of the hand.

The finger-like structure 6 may comprise, in the portion near the center of the base body 4 on the representationally outer side, a protrusion 16 that may serve as a contact surface for the user's thumb. The protrusion 16 may assist in the safe handling of the serving aid 2.

As mentioned above, the serving aid 2 comprises a first tableware-support-portion 18 in which a tableware-item 20 can be arranged and then handled by the serving aid 2.

The finger-like structure 6 comprises a bearing-portion 22 at its upper side, as it is shown, which is also referred to as the first bearing-portion of the first tableware-support-portion 18.

At its free end, the finger-like structure 6 may comprise a formation 24 configured to provide an at least form-fittingly operative-connection with a bottom side of the tableware-item 20 (or a bottom side portion). By an at least form-fittingly operative-connection it is understood in particular that the formation 24 and the bottom side of the tableware-item 26 do not (have to) have complementarily configured surfaces, but that a portion of the bottom side of the tableware-item fits into the formation 24, thereby limiting the freedom of movement of the bottom side portion in the formation 24.

FIG. 2e illustrates the exemplary formation 24 configured to receive a portion of a foot 26 on the bottom side of the tableware-item 20, allowing the portion of the foot 26 in the formation 24 to move, at most, only slightly.

The second finger-like structure 8 comprises a bearing-portion 28, also referred to as a further bearing-portion of the first tableware-support-portion 18.

The bearing-portion 28 may comprise, as it is shown, a downwardly facing bearing surface 30, against which a portion (generally external) of a tableware-item may be supported upwardly.

Further, the bearing-portion 28 may comprise a second support surface 32 oriented substantially the same as the first support surface 30, i.e., also facing downwardly as shown herein. The second bearing surface 32 is disposed on the bottom side of the second support structure 12 as shown; in the illustrated embodiment of the second support structure 12, this is the side opposite the side on which a further tableware-item can be supported, as explained further below.

The surfaces of the bearing-portion 22 and, if present, of the formation 24 are oriented substantially still upwardly, as shown. According to the illustration, the surfaces of the bearing-portion 28 are oriented substantially still at the bottom. Preferably, the surfaces of the bearing-portion 20 and, if present, of the formation 24 comprise at least one portion oriented opposite to at least one portion of the surface 30 and/or the surface 32 of the bearing-portion 28. Thus, it can be achieved that a tableware-item can, on the one hand, be supported at the bottom (by the bearing-portion 22) and, on the other hand, can be supported at the top (by the supporting portion 28). As a result, the tableware-item 20 can be held in a force-fit operative-connection with the serving aid 2 such that a portion of the bottom side of the tableware-item 20 contacts the first bearing-portion 22, preferably such that a portion of the foot 26 of the tableware-item 20 engages the formation 24 as shown, for example, in FIG. 2e; and a portion of an external border 34 of the tableware-item 20 (also called the surface 32) contacts the bearing-portion 28, preferably its surface 30 and/or surface 32.

It is further contemplated that the spatial spacing of the first bearing-portion 22 and the second bearing-portion 28 may be variably adjustable to accommodate tableware-items of different shapes and/or sizes thereat. The variable spatial spacing can be achieved, for example, by making a portion of the base body between the first bearing-portion 22 and the second bearing-portion 28 flexible and/or having two parts, in which the two parts are movable relative to each other. Furthermore, the spatial spacing can be achieved if the first bearing-portion 22 and/or the second bearing-portion 28 are designed as separate components and are each movably connected to the base body 4.

Two bearing surfaces for the bearing-portion 28 may be provided to hold the first tableware-item 20 more stably in the serving aid. However, only one of the bearing surfaces 30 and 32 or at least one other bearing surface may be provided.

In embodiments having the first bearing-portion 22 and the second bearing-portion 28, the force-fit operative connection between the tableware-item 20 and the serving aid may be achieved by the tableware-item 20 being supported from below by the first bearing-portion 22, while the second bearing-portion 28 counteracts tilting of the tableware-item 20. Without the second bearing-portion, the tableware-item 20 would be “balanced” on the first bearing-portion and tend to tilt downward to the right as shown in FIG. 2c, as illustrated there by the arrow K1. Therefore, the tableware-item 20 tends to rest against the second bearing-portion 28 and in this way substantially secures itself.

In further embodiments, there is a further bearing-portion 36, also referred to as a third bearing-portion of the first tableware-support-portion. The bearing-portion 36 may comprise a first bearing surface 38. If the first bearing surface 38 of the third bearing-portion 36 is arranged opposite the first bearing surface 30 of the second bearing-portion, such as the bearing surfaces shown in FIG. 2a, at least parts of these bearing surfaces form a groove.

The bearing surface 30 and/or the support surface 38 may be shaped to form a groove or groove-like structure sized to allow a portion of a tableware-item to be clamped therein. This can be achieved, for example, by an inwardly tapering groove and/or by the bearing-portion 22 and/or the bearing-portion 28 being made of an elastic material at least in the portion of the groove. In this way, a force-fit and/or form-fitting operative connection can be produced when the respective portion of the tableware-item is inserted there. Illustrate FIG. 2 this for a plate 20 whose border of its flag 34 is held between the bearing surface 30 and the supporting surface 38.

In further embodiments, the bearing surface 30 and/or the supporting surface 38 may be shaped to form a groove or groove-like structure into which a portion of a tableware-item may be arranged there with play; that is, may move there to some extent. Referring to FIG. 2, this would mean that the portion of the flag 34 positioned between the bearing surface 30 and the bearing surface 38 can move between them. Again, this provides for securing the tableware-item 20 to the serving aid. As described above, the tableware-item 20 tends to support itself against the second bearing-portion 28; as the tableware-item 20 moves away therefrom, the tableware-item 20 will support itself against the third bearing-portion 36.

The third bearing-portion 36 may comprise a further, second bearing surface 40. As shown in FIG. 2a, the second supporting surface 40 may be adjacent to and tilted with respect to the first supporting surface 38. Such tilting may render the second support surface a positioning aid when a portion of a tableware-item is to be inserted into the space between the first support surface 30 of the second support portion 28 of the first tableware-support-portion 18 and first support surface 38 of the third support portion 36 of the first tableware-support-portion 18.

Using the means described above with respect to FIG. 2, the tableware-item 20 can be brought into operative-connection with the serving aid 2, as illustrated in FIG. 2b, and then handled.

As mentioned above, the serving aid 2 comprises a second tableware-support-portion 42 in which a further tableware-item 44 can be arranged and then handled by the serving aid 2.

The second tableware-support-portion 42 includes the first support structure 10, which is connected to the second finger-like structure.

The first support structure 10 comprises a first bearing-portion 46, which is also referred to as the first bearing-portion of the second tableware-support-portion 42. In use, the tableware-item 44 is positioned offset with respect to the tableware-item 20 such that the tableware-item 44 comprises one or more portions 48 of its bottom side that support on the tableware-item 20, for example on a portion of the outboard border 34 of the tableware-item 20. In this manner, the tableware-item 44 can be positioned above the tableware-item 20 without contacting anything located on the tableware-item 20.

In principle, such positioning of the tableware-item 44 would be sufficient to handle it and the tableware-item 20. However, there is a risk that the tableware-item 44 may tilt during handling and leave its intended position. Thus, in FIG. 3b, the tableware-item 44 can tilt to the right front toward the tableware-item 20 and contact things located there; or it can move to the left rear and fall off.

This can be prevented with the bearing surface 46, which can serve to support the tableware-item 44 in directions opposite to one or more possible movements of the tableware-item 44 leading to it leaving its intended position. For example, the bearing surface 46 may interact with an exterior border 50 of the tableware-item 44. The operative-connection between the bearing surface 46 and the tableware-item 44 may be produced when the tableware-item 44 is positioned in the second tableware-support-portion 42, and then maintained. In further embodiments, the bearing surface 46 is configured such that when the tableware-item 44 is positioned in the second tableware-support-portion 42, contact does not occur until the tableware-item 44 leaves or threatens to leave the desired position.

In further embodiments, there is a second bearing surface 52 that is opposite the bearing surface 46. In this manner, the first bearing surface 46 and the second bearing surface 52 comprise a groove into which a portion of a tableware-item can be inserted.

The bearing surface 46 and the support surface 52 may be parallel to each other, resulting in a groove of substantially the same cross-section, or tilted relative to each other, resulting in a tapered groove.

The groove may be sized such that a portion of a tableware-item, for example the outboard border 50 of the tableware-item 44, may be disposed therein with clearance. Then the tableware-item can move to some extent relative to the bearing surfaces 46 and 52, contacting them only when the tableware-item 44 leaves or threatens to leave the desired position. Then, the tableware-item 44 may be held there by a force-fit operative-connection (e.g., frictional forces), which may prevent it from falling.

In further embodiments, the groove may be dimensioned such that a portion of a tableware-item can be clamped there. This may be achieved, for example, by an inwardly tapering groove and/or by the first support structure being made of an elastic material at least in the portion of the groove.

The overall size, height, width and/or depth of the support structure 10 may vary depending on tableware-items to be handled.

It is further envisaged that the support structure 10 can be configured such that the groove is variable (adjustable). This can be achieved, for example, if the support structure 10 is elastic in the portion of the groove. Furthermore, this can be achieved if the support structure 10 is designed in two parts, so that one part forms, for example, the lower portion of the groove as shown and the other part forms the upper portion of the groove as shown, and the two parts can be moved relative to each other, for example in such a way that, starting from the representation of FIG. 3d, the groove width can be adjusted in the horizontal direction and or the groove depth can be adjusted in the vertical direction.

Using the means described above with respect to FIG. 3, the tableware-item 44 can be brought into operative-connection with the serving aid 2, as illustrated in FIG. 3b, and then handled. In embodiments with only the bearing surface 46, it is generally necessary to also arrange a tableware-item in the first tableware-support-portion. In embodiments with the bearing surfaces 46 and 52 forming a groove, it is also possible to arrange only one tableware-item in the second tableware-support-portion.

As mentioned above, the serving aid 2 comprises a third tableware-support-portion 54 in which another tableware-item 56 can be arranged and then handled by the serving aid 2.

The second tableware-support-portion 42 is defined by the second support structure 12, the upper side of which, as shown, comprises a first bearing surface 58. The first bearing surface 58 may be used alone to support thereon a bottom side of the tableware-item 56. Support of the tableware-item 56 may be improved by the first support structure 10 comprising a second bearing surface 60 attributable to the second tableware-support-portion 42. As illustrated in FIG. 4b, the tableware-item 56 may then be supported by the two bearing surfaces.

The support structure 12 may be configured such that the first bearing surface 58 and the second bearing surface 60 of the third tableware-support-portion 54 lie in a common plane that is parallel to, or tilted relative to at least one of, the plane in which a tableware-item is held in the first tableware-support-portion 18 and/or the plane in which a tableware-item is held in the second tableware-support-portion 42.

The distance between the bearing surface 32 and the supporting surface 58 may be variably adjustable, for example, if the supporting structure 12 is made in two parts and the two parts thereof are movable and positionable relative to each other.

Using the means described above with respect to FIG. 4, the tableware-item 56 can be brought into operative-connection with the serving aid 2, as illustrated in FIG. 4b, and then handled. The use of the third tableware-support-portion 54 is substantially independent of the other two tableware-support-portions; that is, a tableware-item may be disposed in the third tableware-support-portion even if no tableware-item is disposed in the first tableware-support-portion 18 and/or the second tableware-support-portion 42.

Furthermore, it is possible with the serving aid to position “only” one tableware-item in the first tableware-support-portion 18 and one in the third tableware-support-portion 54, i.e. to leave the second tableware-support-portion 42 free. It is also possible to position one tableware-item in the second tableware-support-portion 42 and one in the third tableware-support-portion 54, leaving the first tableware-support-portion 18 free.

FIG. 5 shows another variant of a serving aid that comprises a first tableware-support-portion 18 and a third tableware-support-portion 54, following the previous wording. In other words, the variant of FIG. 5 is the variant of FIGS. 2-4 without a second tableware-support-portion 42. Therefore, the above explanations regarding FIGS. 2 and 3 apply accordingly to the variant of FIG. 5 and are not repeated here.

What is claimed is:

1. A serving aid comprising
a. a first hand-support-surface configured to support the serving aid on a portion of a person's hand;
b. a first tableware-support-portion having a first bearing-portion and a second bearing-portion for supporting a first tableware item, wherein
c. the first and second bearing-portions of the first tableware-support-portion
i. are stationary with relation to each other
ii. are oriented differently, wherein
d. there is a force-fit operative-connection between the first tableware-item, when positioned to contact the first bearing-portion and the second bearing-portion, and the serving aid.

2. The serving aid according to claim 1, wherein
a. the first tableware-support-portion comprises a first third bearing-portion,
b. the second bearing-portion of the first tableware-support-portion and the third bearing-portion of the first tableware-support-portion are oriented substantially opposite to each other.

3. The serving aid according to the preceding claim, wherein the first bearing-portion of the first tableware-support-portion and the third bearing-portion of the first tableware-support-portion define a groove-like structure.

4. The serving aid according to any one of the preceding claims, wherein the first bearing-portion of the first tableware-support-portion comprises a structured portion.

5. The serving aid according to the previous claim, wherein the structured portion of the first bearing-portion of the first tableware-support-portion comprises a recess configured to form-fittingly receive a portion of the first tableware-item.

6. The serving aid according to any one of the preceding claims further comprising
a. a second tableware-support-portion having a first bearing-portion for supporting a second tableware-item, wherein
b. the first bearing-portion of the second tableware-support-portion
i. and the second bearing-portion of the first tableware-support-portion are stationary with respect to each other,
ii. and the second bearing-portion of the first tableware-support-portion are oriented substantially the same.

7. The serving aid according to the preceding claim, wherein
a. the second tableware-support-portion comprises a second bearing-portion for supporting the second tableware-item, wherein
b. the first bearing-portion and the second bearing-portion of the second tableware-support-portion
i. are stationary with respect to each other,
ii. are oriented differently.

8. The serving aid according to the previous claim, wherein the first bearing-portion and the second bearing-portion of the second tableware-support-portion define a groove.

9. The serving aid according to any one of the preceding claims, comprising.
a. a third tableware-support-portion having a first bearing-portion for supporting a third tableware-item, wherein
b. the first bearing-portion of the third tableware-support-portion defining a tableware-support-portion for supporting a bottom side of the third tableware-item.

10. The serving aid according to the preceding claim, wherein
a. the third tableware-support-portion comprises a second bearing-portion for supporting the third tableware-item, wherein
b. the first bearing-portion and the second bearing-portion of the third tableware-support-portion
i. are stationary with respect to each other,
ii. are oriented substantially the same.

11. The serving aid according to any one of the preceding claims, wherein at least one of the bearing-portions comprises at least partially elastic and/or anti-slip material.

12. A computer software product comprising executable software code stored on a computer-readable medium which, when executed by a computer device, performs the following steps:
a. producing a first hand-support-surface configured to support the serving aid on a portion of a person's hand;
b. producing a first tableware-support-portion having a first bearing-portion and a second bearing-portion for supporting a first tableware-item, wherein
c. the first and second bearing-portions of the first tableware-support-portion being
i. are stationary with respect to each other,
ii. are oriented differently such that
d. there is a force-fit operative-connection between the first tableware-item, when positioned to contact the first bearing-portion and the second bearing-portion, and the serving aid.

13. The computer software product according to the preceding claim, wherein the executable software code, when executed by a computer device, performs steps to produce a serving aid according to any one of claims 1 to 11.

14. The computer software product according to any of the preceding claims, wherein the executable software code is adapted to control a 3D printer.
